(19) United States
(12) Patent Application Publication
(10) Pub. No.: US 2019/0087863 A1
(43) Pub. Date: Mar. 21, 2019

(54) CELLULAR PHONE WITH AUTOMATIC ADVERTISING

(71) Applicant: Nuvo LLC, Chicago, IL (US)

(72) Inventors: Thomas John Mannix, Forest Park, IL (US); David K. Murphy, Columbus, OH (US); Ian Kelly, Chicago, IL (US); Joseph M. Donaghy, Oakland, CA (US)

(21) Appl. No.: 16/193,678

(22) Filed: Nov. 16, 2018

Related U.S. Application Data
(63) Continuation of application No. 15/787,401, filed on Oct. 18, 2017, now abandoned.
Application No. 15/787,401 is a continuation-in-part of application No. 14/271,007, filed on May 6, 2014, now abandoned.
(60) Provisional application No. 61/819,818, filed on May 6, 2013.

(51) Int. Cl. G06Q 30/02; G06Q 20/24; H04M 1/725; H04W 4/02

(52) U.S. Cl. CPC G06Q 30/0264; G06Q 30/02; G06Q 20/24; G06Q 30/0261; G06Q 30/0277; H04M 1/72552; G06Q 30/0272; G06Q 30/0267; H04W 4/02; H04M 1/72572; H04M 1/72597; H04M 1/72569

(57) ABSTRACT

A device, such as a cellular phone, includes an audio and visual display configured to identify content entered by a user of the device and to automatically initiate a select message file related to the content entered as a result of a user-initiated implementation of a predetermined feature of the device that is not related to the message file and to allow the user-initiated implementation of the predetermined feature to proceed only after the user closes the select message.

### CROSS-REFERENCE TO RELATED APPLICATIONS

This application is a continuation of U.S. patent application Ser. No. 15/787,401, filed Oct. 18, 2017, which is a continuation-in-part of U.S. patent application No. 14/271,007, filed May 6, 2014, which claims the benefit of U.S. Provisional Patent Application No. 61/819,818, filed May 6, 2013, the contents of which are each hereby incorporated by reference herein in their entireties.

### FIELD OF THE INVENTION

The present invention generally relates to a smart phone or other similar device configured to present messages upon activation of certain features of the device, and more particularly, to a device configured to present messages, advertising and/or surveys upon user interactions, device actions and/or activation of certain features of the device.

### BACKGROUND OF THE INVENTION

Cellular phones, especially smart phones, and other devices (e.g., tablets) can be cost prohibitive for many people. That is, the cost of the phone or device itself and/or the monthly service fees, prevent many people from owning such phones or devices and taking advantages of the many capabilities and features provided by them.

The present invention provides an improved smart phone or other device configured to implement or display messages, advertisements or surveys triggered by specific actions of the user, operation of the device or its features and/or other factors (e.g., proximity of phone to a store; content of media viewed on the phone, etc.). The resulting revenue can be used to reduce or eliminate the cost of the phone or device to the user.

### SUMMARY OF THE INVENTION

The present invention provides a smart phone or other similar device (e.g., a tablet, electronic game, computer, MP3 device and other music players, etc.) configured to initiate messages, advertisements, surveys or other similar media, in response to specific actions of the phone/device of the phone/device user. The messages or advertisements can take the form of an audio message, brief video, a visual image, a website link or any combination of or all of the aforementioned. Advertisements can be a simple brand logo or image, a silent animated image or video, or an audio/video mini-commercial. The average time of each advertisement can be, for example, 5 to 8 seconds.

A large variety of actions can be utilized to implement one or more messages. such as advertisements. For example, a swipe to access operation of the handset; the entry of a security code to unlock and access operation of the handset; the reception of a voicemail, text message or email message; the acceptance or retrieval of a voicemail, text message or email message; the termination of a voice call, headset plug-in, Bluetooth headset activation, etc. Similarly, initiation or termination of any other application on the phone can be used to initiate a message, advertisement, etc.

The phone or device can also be configured to implement messages based on text message word content; internet subject/product searches; user demographic, geographic and usage data. Message delivery can also be based on function frequency (e.g.—every third call/text/email/song), or user geographic location (regional and real time) (e.g.—User proximity to a restaurant or point of interest or landmark). Advertisement delivery can also be integrated into a Calendar function with pre-date reminders.

The following provides a non-exhaustive list of existing and potential actions that can be used to trigger or display, messages, advertisements, or surveys:
The swipe of the notification bar.
The presence of a user.
The activation of the mute function of the handset.
The activation of the headphone function of the handset.
The activation of the bluetooth function of the handset.
The activation of the “airplane mode” function of the handset.
The start or completion of any syncing function (either direct connect or cloud based).
The successful connection to or disconnection from a Wi-Fi source.
The successful connection of any bluetooth device.
The opening of any browser.
The opening of any application.
The opening of the user contact list.
The placement of a telephone call (in lieu of, or prior to, the “ringing sound” of the other line).
The device receiving a text message.
The device receiving, missing or ending a phone call.
The device receiving an email.
The device receiving a push notification.
The device receiving a calendar alert.

Similarly, text messages or other notifications can be sent to the user device upon the entrance of the phone into a certain geographic area as determined by GPS coordinates. Also, live or automated telephone calls can be made to the user device upon the entrance of the phone into a certain geographic area as determined by GPS coordinates. The cellular phone or other device can also be configured to provide live syncing of event notifications to Calendar applications along with corresponding advertisements and/or discount coupons related to the event (e.g.—20% discount entry to Illinois State Fair based on GPS location proximity to Springfield, Ill. and/or agricultural browser searches and/or agricultural text message content).

The features of the cellular telephone of the present invention can also be integrated with computers and tablets as they become hybrid cell phone-computer devices.

In accordance with one embodiment, a wireless device—such as a smart, cellular phone (typically having a touch sensitive screen)—is provided comprising an audio and visual display and a processor, running an operating system and other software, coupled to the display. The device is configured to initiate a select audio and/or visual file upon implementation of a predetermined feature of the phone including user action or operating system event.

The select audio and/or visual file can be one or more messages, advertisements or surveys. The messages, advertisements or surveys can be selected based on a number of criteria such as, for example, geographical location of the device (i.e., based on the GPS capabilities of the device), demographic data or personal data provided through surveys or usage statistics of the device or textual data sent to or from the device (e.g., in a text message or e-mail). Other criteria (including that from third party providers) can also be used to provide a more directed/targeted message, advertisement or survey.

A large number of features or capabilities of the device can be used to initiate the display of the messages, advertisements or surveys. For example, the predetermined feature can be activation of the phone by swiping the display.

Further aspects of the invention are disclosed in the Figures and are described herein.

### BRIEF DESCRIPTION OF THE DRAWINGS

To understand the present invention, it will now be described by way of example, with reference to the accompanying figures in which:

FIG. 1 is a front plan view of a phone before being opened (via a finger swipe) and after being opened showing an advertisement;

FIG. 2 is a flow chart showing flow of information and creation of messages in accordance with the present invention; and,

FIGS. 3-12 are flow charts illustrating aspects of the present invention.

FIG. 13 is a flowchart showing a process that may be implemented on a cellular phone system or similar wireless-type devices.

### DETAILED DESCRIPTION

While this invention is susceptible of embodiments in many different forms, there is shown in the Figures, and will herein be described in detail preferred embodiments of the invention with the understanding that the present disclosure is to be considered as an exemplification of the principles of the invention and is not intended to limit the broad aspect of the invention to the embodiments illustrated.

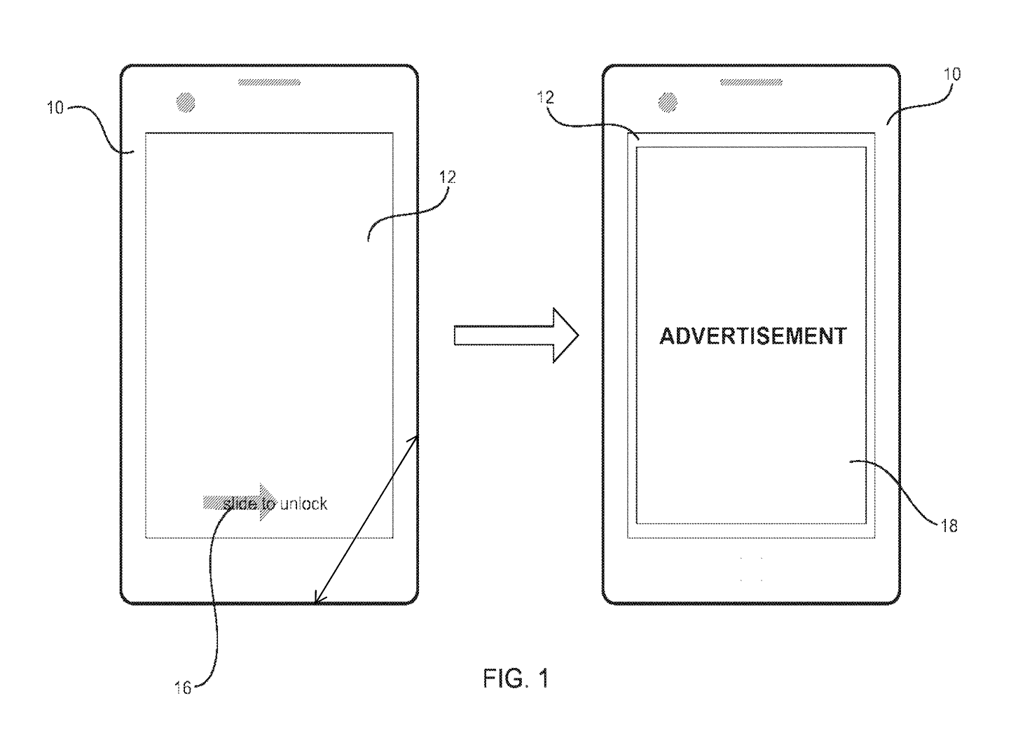

FIG. 1 shows a typical smart phone 10 having a centrally located display 12. The smart phone 10 also includes a speaker and has both audio and video capability.

As illustrated in FIG. 1, activating the phone 10, such as by swiping or sliding an unlock arrow 16 (as shown on the left side of FIG. 1), triggers the phone to show a video or static advertisement 18 (shown on the right side of FIG. 1). As discussed herein, many other actions, either by the device itself or upon user activation, can trigger an advertisement or other messages.

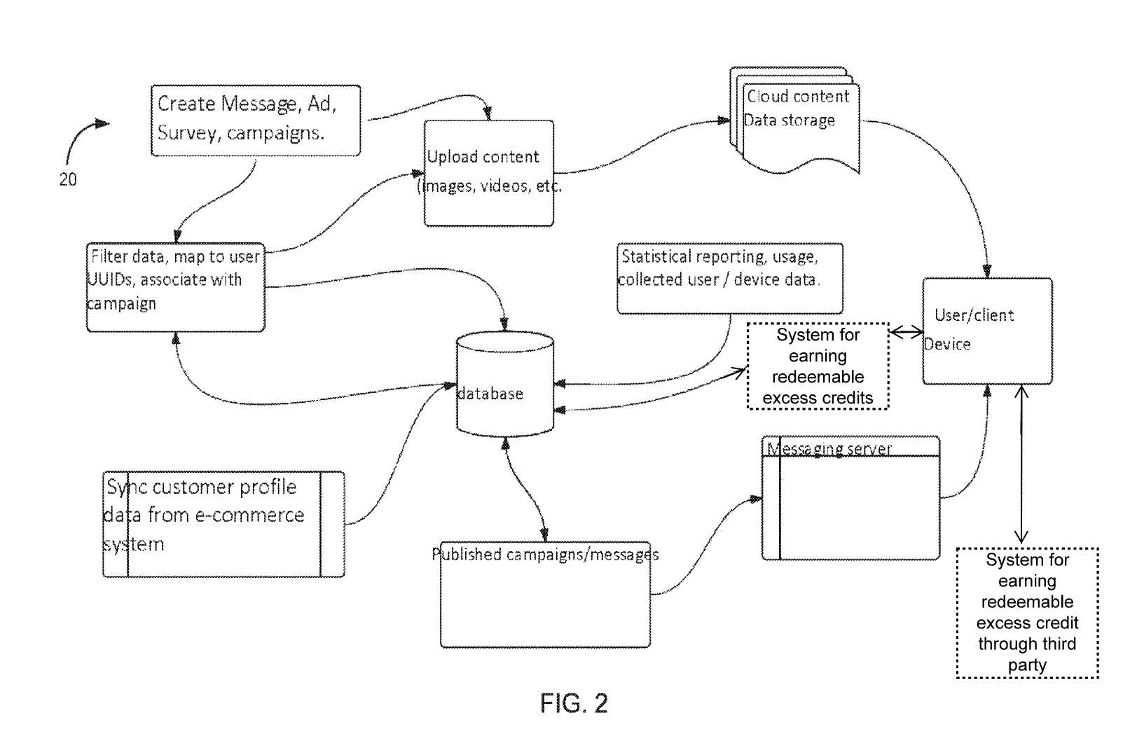

FIG. 2 provides a flow chart 20 that illustrates components of the invention for gathering user information and generating messages.

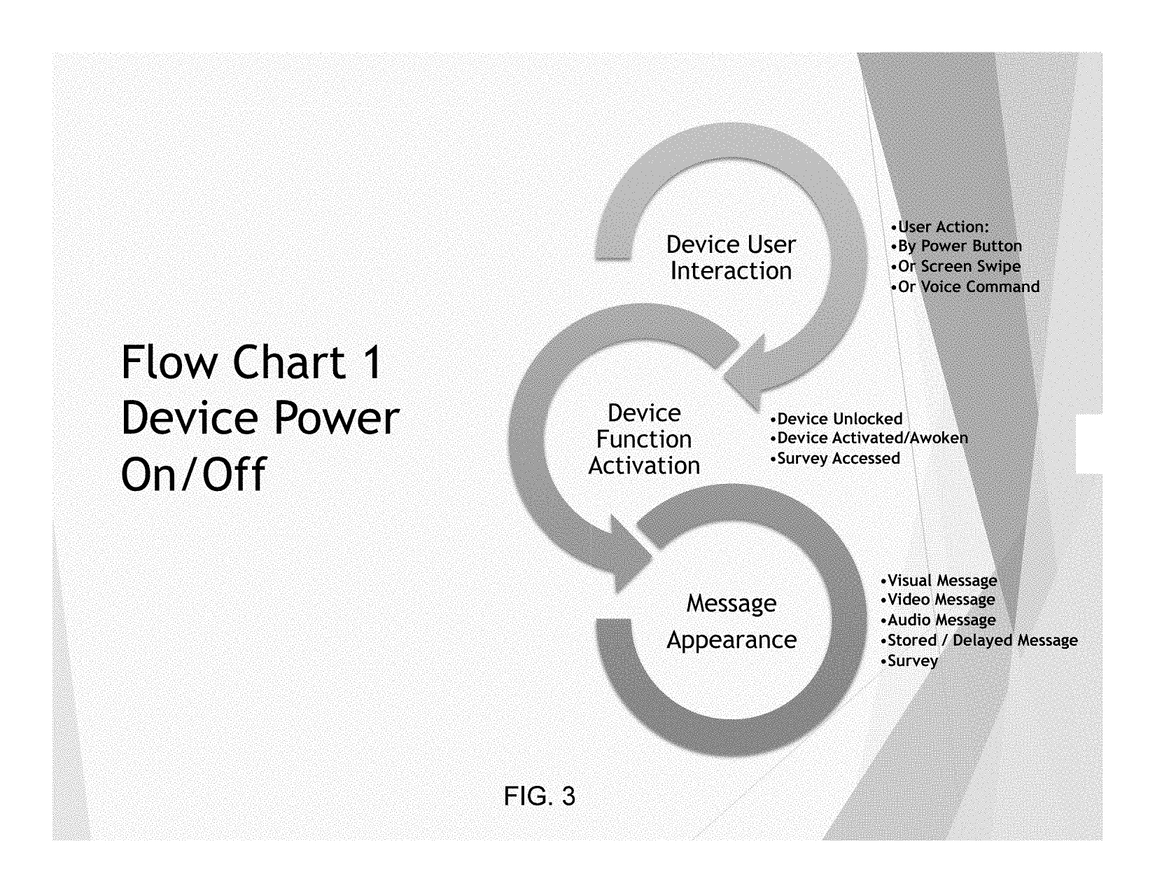

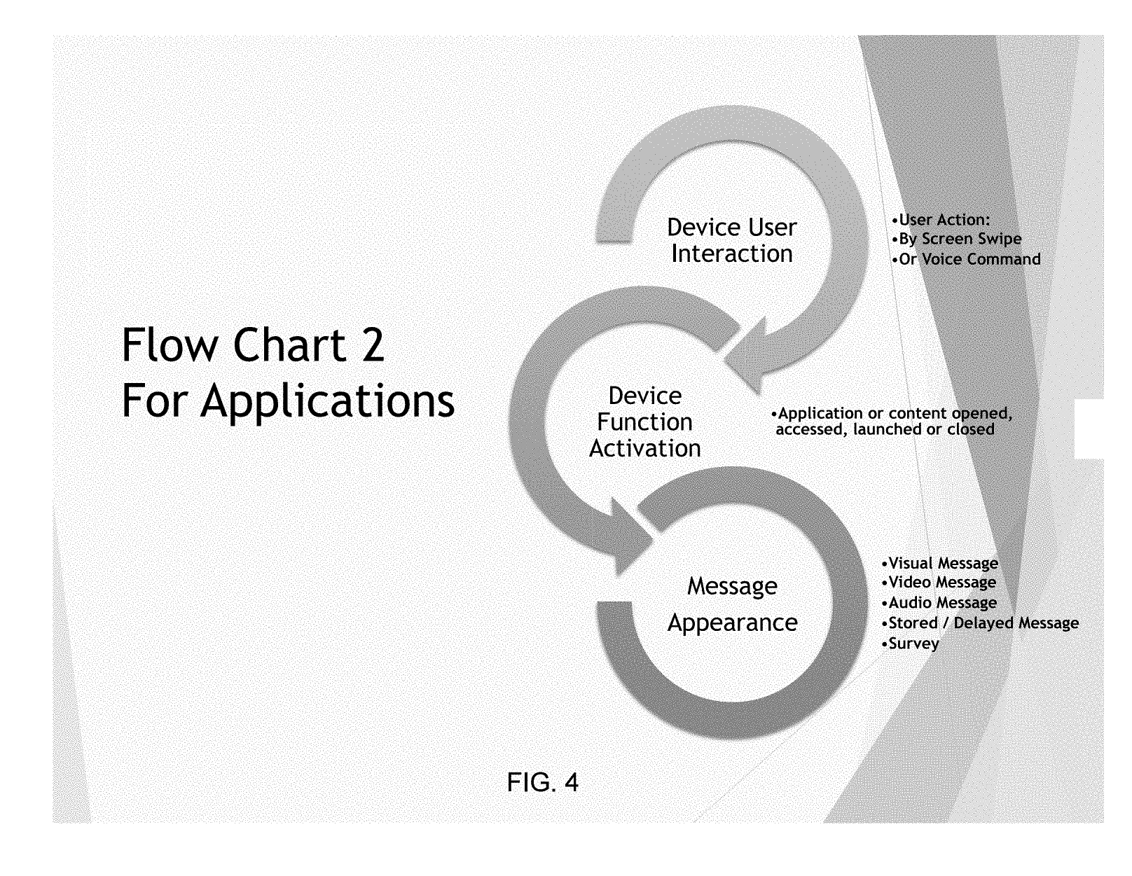

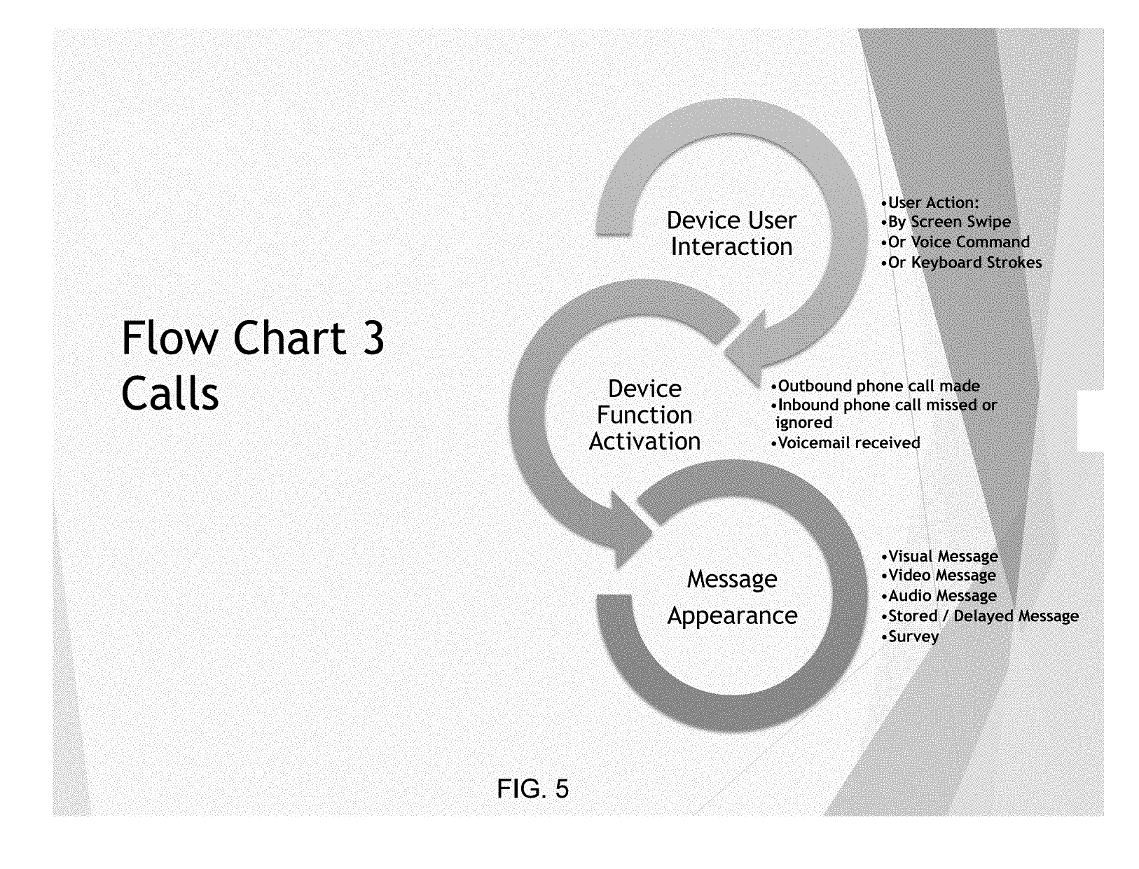

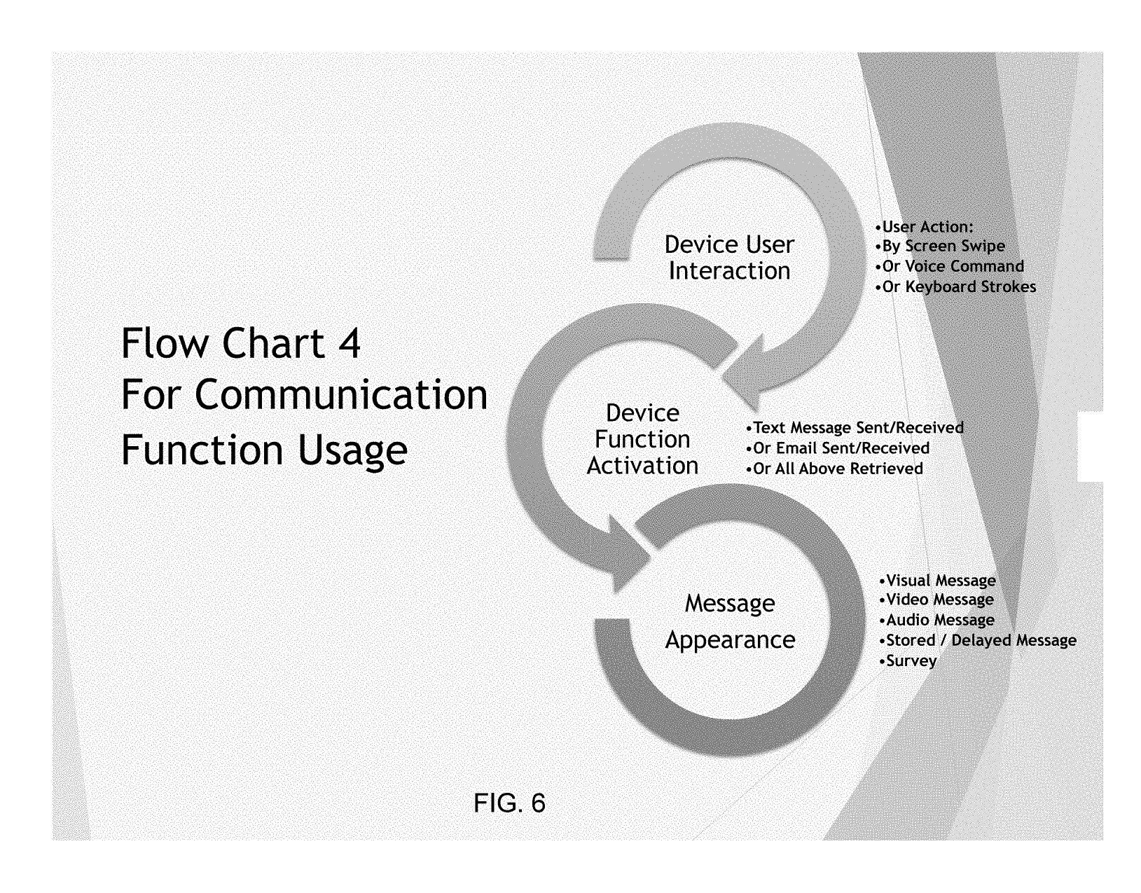

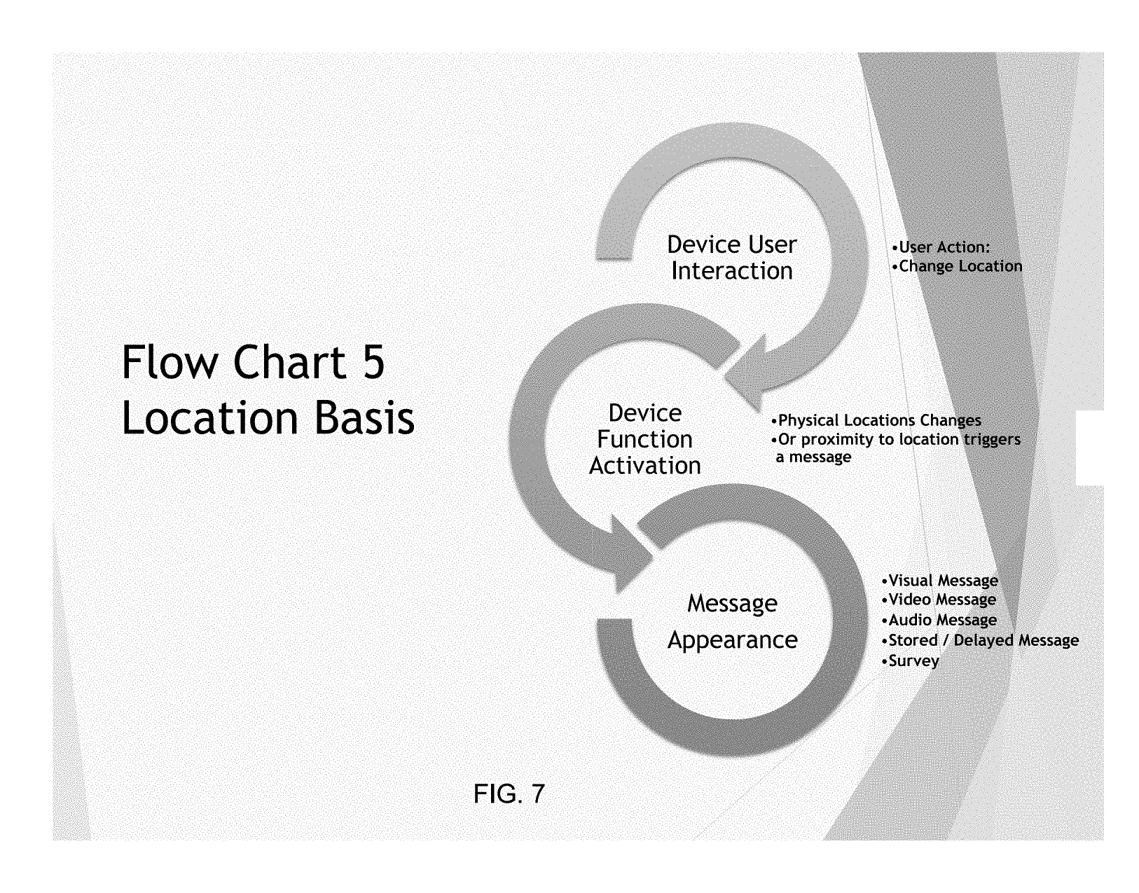

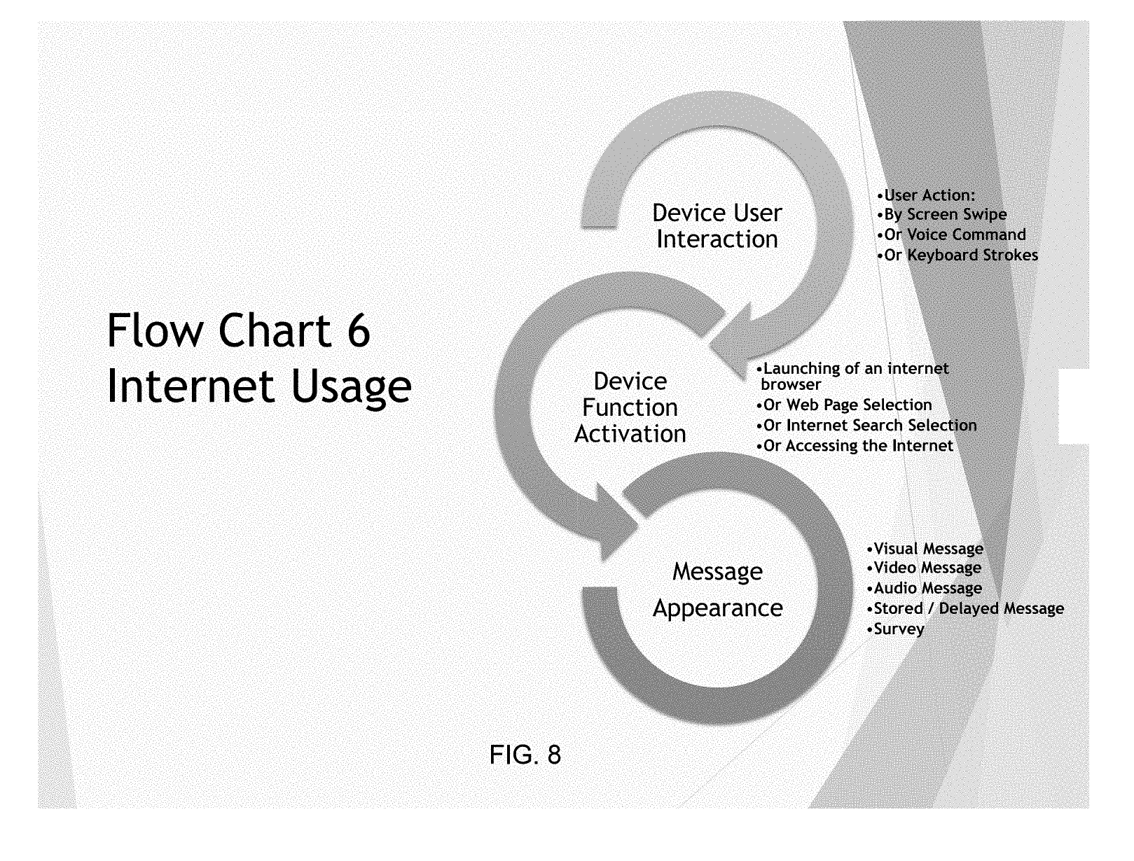

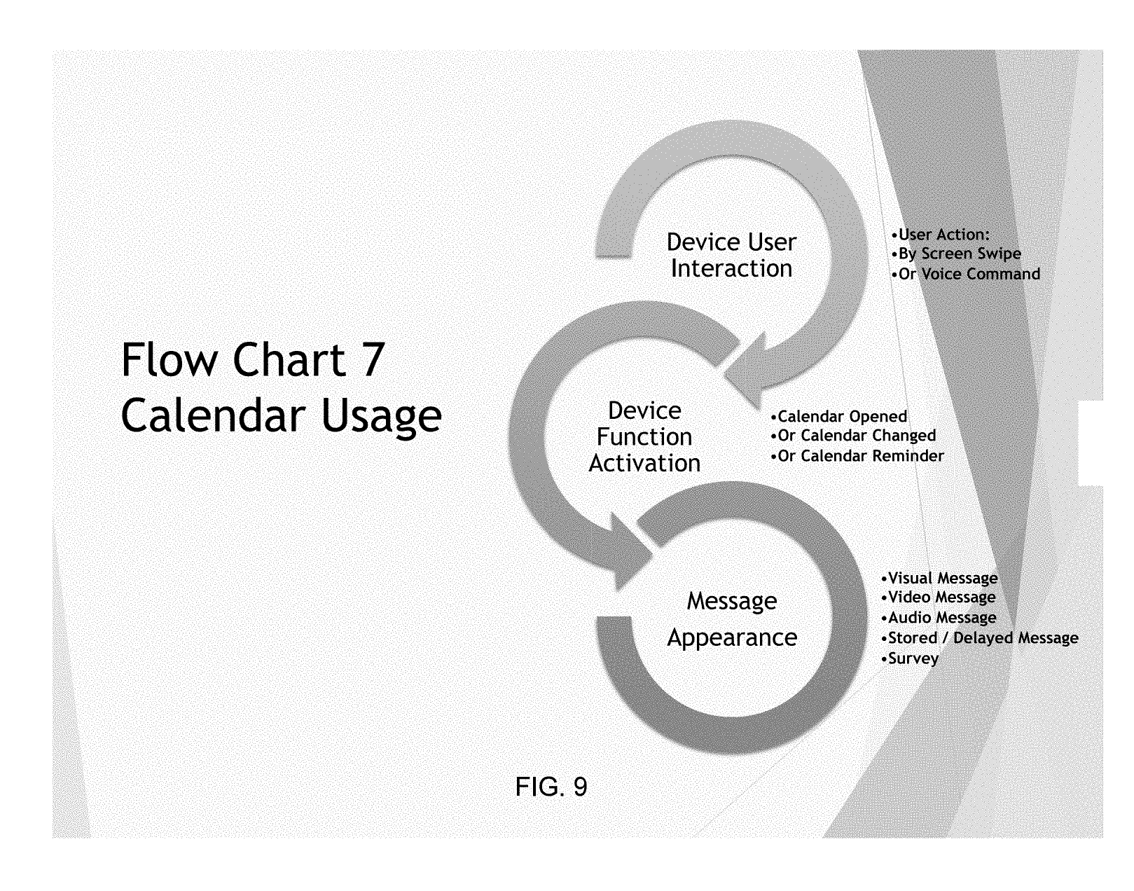

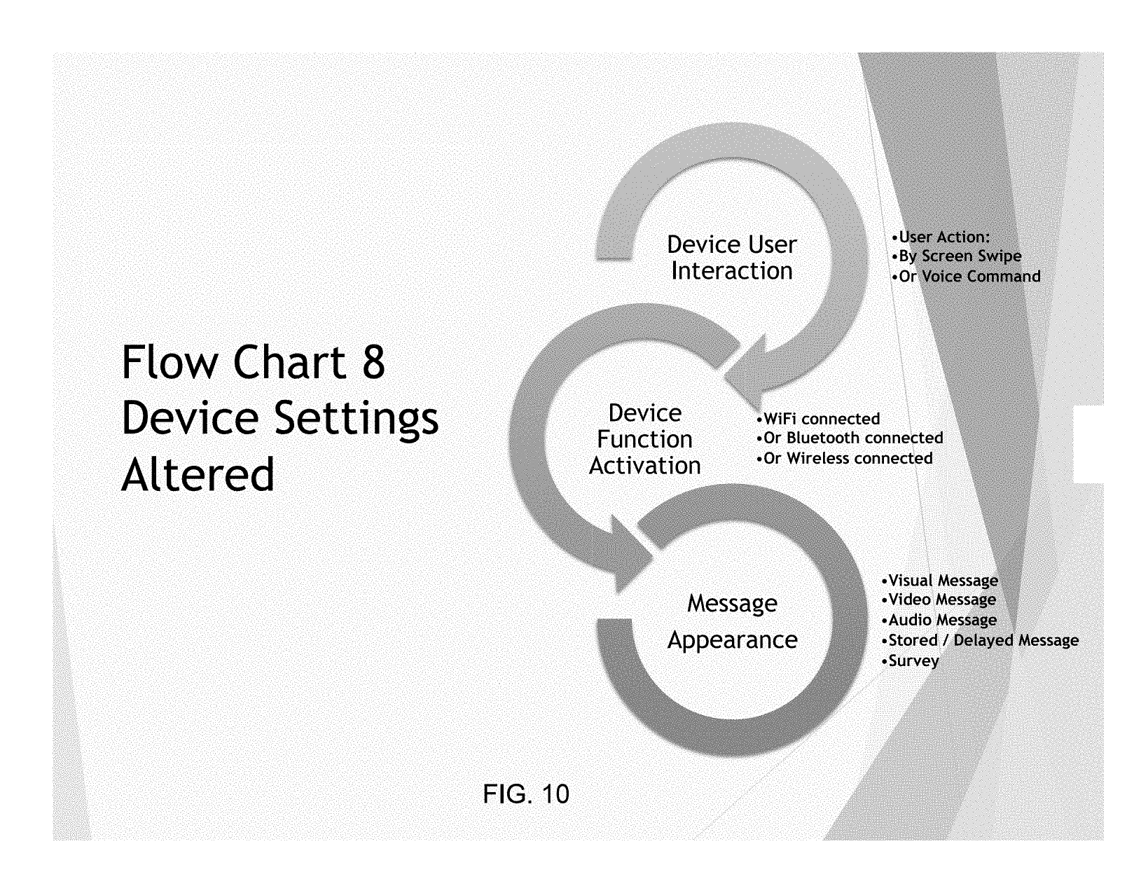

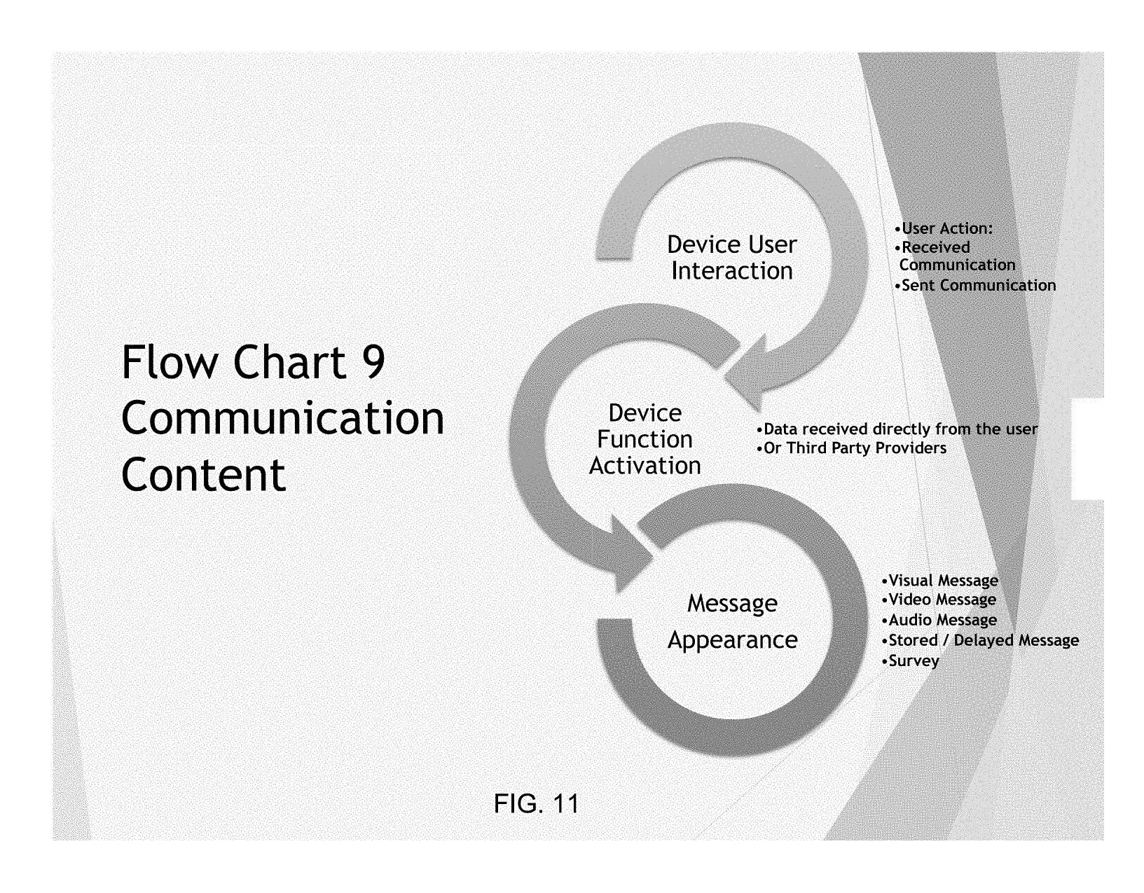

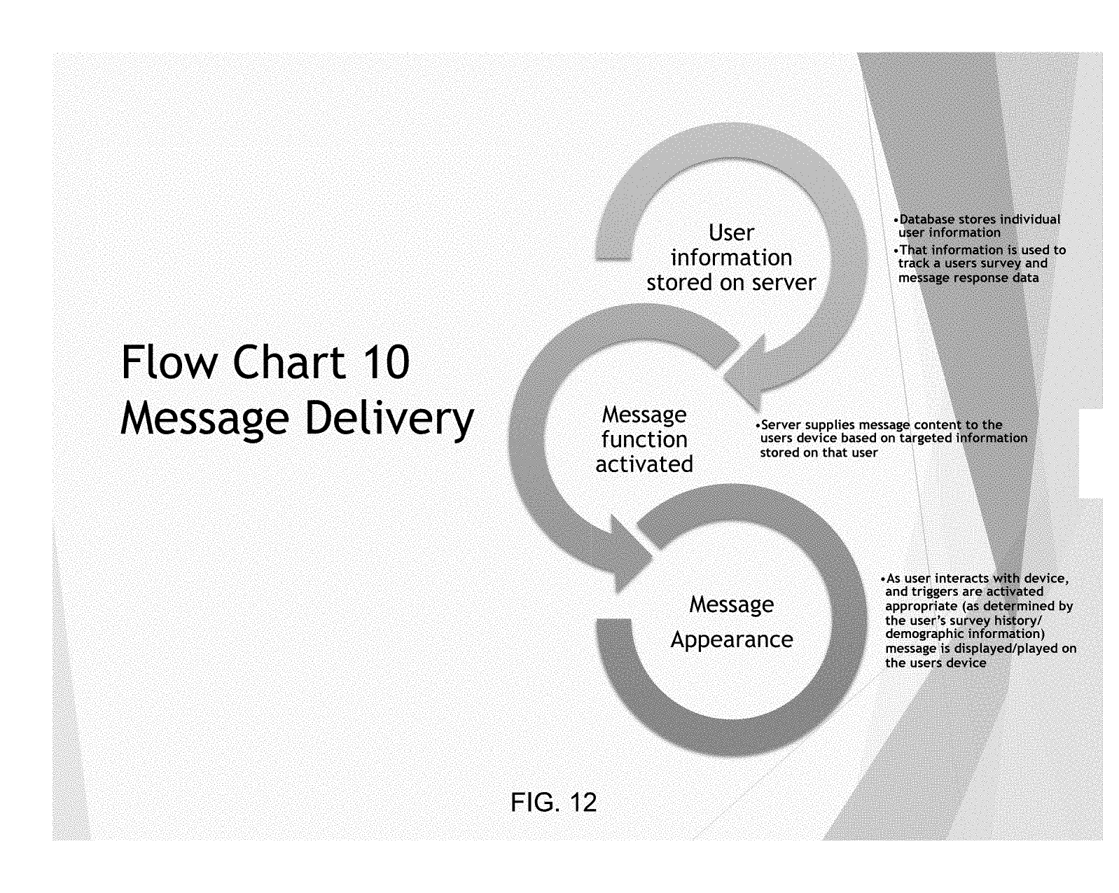

FIGS. 3-12 are flow charts illustrating instances of use of the present system. Each identifies one or more “Device User Interaction,” one or more “Device Function Activation” and one or more “Message Appearance” resulting from the user interaction and function activation.

The present invention generally relates to a device and system comprising client and server software components that are designed to communicate with each other for the purpose of delivering messages (via the device) to uniquely identifiable individual users and providing a variety of methods for displaying delivered messages to the user.

Although sometimes listed collectively, “message” (or message file) is defined herein as being or including any of text messages, advertisements, digital audio and video files, digital still and animated images, computer software applications or games as well as interactive surveys and questionnaires, or other similar items.

The present invention can be thought of as an improved messaging or advertising delivery system and process. The system/process can deliver messages to unique individuals in addition to larger groups or classes of individuals and also record and associate device usage data and statistics, geographic locations, demographic data, advertisement interaction (views, impressions, clicks) and user-submitted data (responses to surveys or questionnaires) with the aforementioned unique individual user in a database. This association of collected usage data with a unique individual is recorded in an on-going and permanent basis in a database.

The user-associated data serves as a historical profile of individuals that may be searched or queried so that messages may be sent to the individual based on one or more matching criteria existing in the user's profile.

The software server components (hereafter referred to as the “server”) permit a sender to select one or more individuals as well as one or more groups or classes of multiple individuals and designate them as intended recipients of a message based on usage statistics, demographic data, geographic data, user-submitted data or any other data contained in the user's historical profile.

The server is configured to provide a method for creating an interactive survey or questionnaire which presents an individual user with a request for a response in the form of choosing between one or more defined text choices or options, images, audio and/or video clips or requesting the user respond with entered text (typing an answer to a question), submit recorded audio, still images, video captures or any other type of data generated or captured by the recipient's client device.

The server is also configured to provide a method for receiving, storing and transmitting messages to the designated recipients via wired or wireless computer networks including but not limited to IP (Internet Protocol) and/or cellular phone networks.

The server associates a permanent unique value with each message. This unique value is a string of data that is generated using modern cryptographic techniques that guarantee a high mathematical probability of being universally or globally unique (often referred to as GUID or UUID—Globally or Universally Unique Identifier in modern software programming terms.) The server associates message UUIDs with individual user UUIDs for the purposes of determining message recipients and generating statistical data.

The system contains software client components (hereafter referred to as the “client”) that communicate with the software server components. The client software performs three primary functions: presenting individual users with messages, recording user interaction with the messages as well as data generated by the device (e.g., GPS coordinates), and transmitting the recorded data to the server.

The client presents messages to the recipient device's user utilizing one or more methods. The message may be displayed in the form of a full or partial screen area containing a text message, still image or video, interactive survey or may be presented as a non-visual audio-only file.

Full or partial screen areas containing visual messages or audio-only messages may be presented to the user at any time during the user's interaction with the device. These messages may be presented as a direct result of a specific user-initiated interaction with the device (e.g., swiping or tapping a screen, answering a phone call, taking a photograph, etc.), as a result of one or more conditions being met by the device (e.g., device is in proximity to a defined GPS coordinate, battery reaches a defined charge state, etc.) or by one or more programmatic business rules defined by the operator such as predefined time intervals and frequency of device events.

The functionality described herein, is implemented, at least in part, by software residing on the device. The software can work with the operating system to implement the messaging. The specific messages can be selected by a service provider system (e.g., server/database). The service provider system can utilize user or device data to provide a message applicable to the user (e.g., directed advertisement—based on specific user data such as age, gender, occupation, etc.).

In the case of the client operating on a smartphone, specific examples of message presentation may include the following:

1. Upon a user logging in, unlocking, or initiating general interaction with the device.

2. Upon receipt of an SMS text message from a cellular phone network.

3. Upon the initiation or termination of a voice phone call.

4. Upon connection or disconnection of wired or wireless headphones.

5. Upon connection or disconnection of Bluetooth devices.

6. Upon connection or disconnection of AC electrical power to the device.

7. Upon a defined battery charge state.

8. Upon the device's proximity to defined GPS coordinates.

9. Upon specific times and dates or upon defined time intervals.

10. Upon enabling or disabling of a device's “airplane mode” (all radios transmitters in the off state).

11. Upon taking a photograph with a camera-equipped device.

12. Upon defined event frequencies (e.g., every third phone call, every fifth photograph, every 10 megabytes of data transmitted or received).

13. Upon interaction with another message.

The client records and transmits collected data along with a permanent unique value to the server. This unique value is a string of data that is generated using modern cryptographic techniques that guarantee a high probability of being universally or globally unique (often referred to as GUID or UUID—Globally or Universally Unique Identifier in modern software programming terms.) This unique value is associated with the user's historical profile in the database.

Following programmatic business logic, the client can periodically query the server for new messages associated with the user's unique value.

The client retrieves any available new messages and stores or caches these messages on the user's device without interaction by the user. When required for presentation, cached messages are retrieved from the user's device for immediate display. Data such as user interaction with messages, device data, location data, etc. is also stored or cached on the user's device and periodically submitted to the server. This functionality permits the client to continue to display messages and record usage data without persistent network connectivity (no signal).

The client may additionally operate in real-time manner, retrieving new messages and transmitting collected data to the server in any environment that provides persistent network connectivity.

The following describes operation of the device and some instances that can trigger an audio and/or visual advertisement:

In operation, a user of the cellular smartphone 10 or other electronic device would experience, upon unlocking the device, presentation of an advertisement, message or survey. Upon closing the message, advertisement or survey, the user is granted access to all normal/typical functions of the device. That is, the home screen of the smartphone 10 would appear after the message allowing the user a choice of functions. Upon activating a function such as opening an email application, the phone may trigger the appearance of another advertisement.

The advertisement can be specific to content on the phone. For example, upon swiping the screen to open an e-mail that contains textual content regarding, for instance, walking a dog, the user would trigger a message or advertisement related to the content in some manner (e.g., an advertisement or coupon for dog food). Similarly, viewing an article or video regarding pets could trigger a similar advertisement or coupon.

By swiping the screen to switch to the application to dial a phone call, the user would trigger another advertisement appearing on the screen and/or through the speaker. Upon swiping to dial the call, the user would hear an advertisement during the time period when the recipients' phone is ringing and the user/caller is waiting for the recipient to answer the call. Similarly, upon swiping to end the call, the user would hear another advertisement, or the device would display another message, advertisement or survey. In the event of a missed call a text message, advertisement is sent to the notification area.

Upon receiving a text message a text advertisement is instantly displayed in the status/notification bar and remains displayed in the notification drawer/area until removed by the user. It should be noted that any of the message, advertisement or survey formats can be displayed after any trigger.

The frequency of advertisement appearance can be determined by a number of factors. For example, the frequency of advertisement appearance can be determined by the frequency of the usage of the functions and applications of the smartphone by the user. In this instance, the phone can be configured such that the more frequent the usage, the less frequent the appearance of the advertisements. This can be done in order to enhance the enjoyment of the use of the device by the user by not unduly subjecting the user to too many advertisements. Alternatively, the frequency can be controlled by the service provider.

Other examples of potential applications of the system are described below:

1. In the case of modern “smart” televisions, set-top box, computer gaming consoles, media streaming devices or other entertainment systems comprising a combination of a display screen, computer operating system and some form of wired or wireless network connectivity, the system can function as addressing and messaging a household or family. The system may be configured to permit a user a choice of viewing options such as charging a standard fee for viewing/streaming content, charging a reduced fee with the requirement of viewing some number of messages or further discounting or eliminating fees in exchange for displaying a greater number of messages. Messages may be displayed before, during (commercial breaks) or after content viewing dependent upon business rules. Additionally, modern entertainment devices equipped with sensors such as cameras, infrared or radio based motion detection may be utilized by the system to determine the presence of a user in proximity to the device and permit messaging only when a user is present (i.e., pause ad when user leaves room).

2. In the case of Internet service comprising of wired or wireless network connectivity to the Internet, the system may be configured by the network operator to insert messages in a user's web browser by temporary redirection of their network traffic to the server at some interval or upon some user operation as defined by business rules before redirecting the user to their intended network address (e.g., present message after every 100 Mb of data traffic, upon request of one or more specific urls, or at defined intervals such as every 30 minutes).

3. In the case of an electronic display or public address system equipped with network connectivity and located in a public space, the system may be configured to deliver targeted messages to individuals or groups via the display or loudspeaker. Individual or groups may be identified and selected for messaging based on proximity to the display. Examples of public or common displays include movie theaters, billboards, kiosks, electronic scoreboards at sporting events, public televisions (e.g., at airport lounges, bars and restaurants), public video or audio jukeboxes, and computer arcade games. Additionally, the system may be configured to present a message to a user's individual client device based on receipt of a previous message delivered by a public display (user received message from a display at a shopping mall and receives a related message on their personal device).

4. In any case of personal “wearable” computing devices comprising a display screen, heads-up display, goggle, eyeglass and/or loudspeaker/headphone combined with a computer operating system and network connectivity, the system may be configured to present messages utilizing one or more methods described above.

Aspects of the present disclosure include systems for user or client devices connected to a communications network, such as a cellular or wireless network, to accumulate redeemable credits based on interactive advertising, messaging, or surveys received by the user or client device. (See exemplary FIG. 2 features including references to “System for earning redeemable excess credits” and “System for earning redeemable excess credits through third party”). The advertising, messages, or surveys may or may not be specifically targeted to the user based on content entered by a user into the device. The redeemable credits have value to a user within the network by allowing the user access to the network via the client device or otherwise (e.g., via another device over an internet connection with access to an associated user account) the option to redeem the credits for bandwidth on the network. For example, a user may redeem credits for smartphone usage (e.g., data or call time) from a cellular or wireless service provider on the network. In some aspects, excess accumulated credits and their associated value that are not redeemed by a user for bandwidth are retained by a system providing the credits redeemable for bandwidth (e.g., third-party server, cellular provider).

In some aspects, it is contemplated that the redeemable credits may be stored on third-party server(s) or other servers configured to allow storage and redemption of the accumulated excess credits in unique user accounts for the users of the communication network. The server(s) are connected to the communications network such that communications over the network occur either directly or indirectly with both the user or client devices. For example, in some aspects communication may occur with the server through a cellular or wireless service provider interface. The server(s) can track the accumulation of excess credits associated with a specific user after the user or client device has provided confirmation that a select message has been received and/or closed by the device. Determination of whether the message has been received or closed is associated with user inputs received by or through the user or client device. The user or client device can further interface with the server(s) or other linked servers to make selections for items of value the user may wish to redeem.

It is contemplated a server storing the redeemable excess credits or another server be configured to conduct transactions with the cellular or wireless service provider or other servers on the communications network. For example, the transaction can initiate further actions that result in the item(s) of value being received by the user of the device in exchange for some or all of the accumulated excess credits the user may have accumulated in an associated user account.

In some aspects it is contemplate that third-party systems (e.g., via a server connected to the communications network—see exemplary FIG. 2 reference to “System for earning redeemable excess credit through third party”) are configured with unique user accounts linked to or otherwise tied to a cellular or wireless network user (e.g., a smartphone user). The system allows the unique user of a unique user account to externally redeem any excess credits received and accumulated from the third-party system by the user. In some aspects, the redeemable credits may be redeemed for items of value at predetermined per credit exchange rate. It is contemplated that the redemption is facilitated through the third-party system and another party that allows items of value to be received from another party also connected to the communications network. For example, accumulated excess credits can be uploaded or stored on to a unique user or client account. The excess or accumulated credits are then reduced or expended by the user through the third-party system or another party issuing an alternate item or credit of value to the user. In some aspects, a debit card may be issued directly by the third party system. In other aspects, another external system (e.g., different from the third-party system) may, through a transaction with the third-party system, credit a digital payment application account of users/clients, such as the systems currently available including Google Wallet, Apple Pay, and similar digital payment application accounts. In some aspects, credit to the digital payment application account may be issued directly to an account operated by or through the third—party system itself that is storing and allowing redemption of the accumulated credits by users/clients.

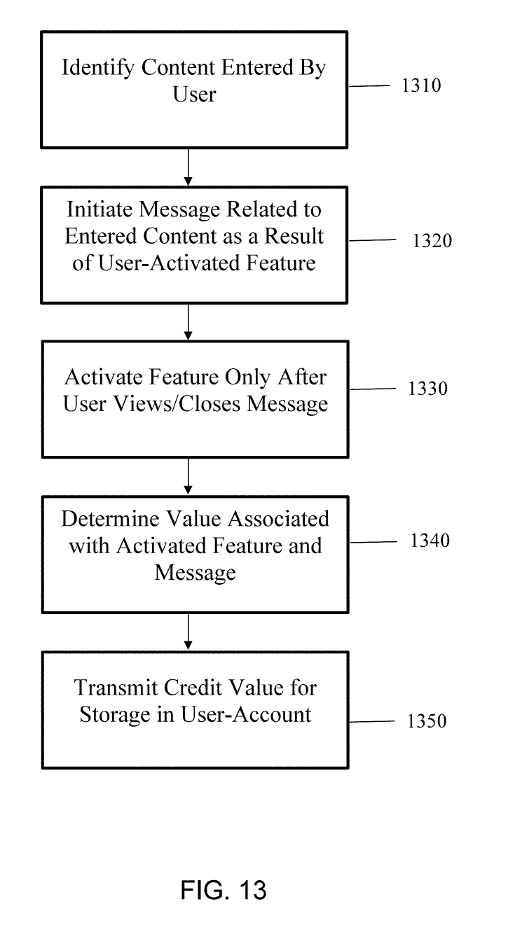

Referring now to FIG. 13, an exemplary flowchart illustrates a process that may be implemented on a cellular phone system or similar wireless-type devices or networks. The process may include a series of instructions stored in a physical memory device that when executed on one or more processors, results in implementation of certain acts. In step 1310, content entered by a user of the system is identified. Next in step 1320, a message related to the entered content is automatically initiated on the display as a result of a user-activated feature of the phone that is not related to the message. Then, in step 1330, the feature is activated only after the user closes the message. In step 1340, in response to the user closing the message, a credit value is determined that is associated with the activated feature and the message. Then, in step 1350, the credit value can then be transmitted to a communications interface for receipt and storage by a third-party server over a network connected to the cellular phone system. The credit value may be stored in a user-account associated with the user of the cellular phone system.

In some aspect of the above system, after the credit value exceeds a predetermined threshold value, options are provided for items of value to be redeemed in exchange for a credit value exceeding the threshold value. It is further contemplated that the items of value may be stored on third-party servers external to the cellular phone system.

Many modifications and variations of the present invention are possible in light of the above teachings. It is, therefore, to be understood within the scope of the appended claims the invention may be protected otherwise than as specifically described.

We claim:

1. A device comprising:
an audio and visual display; and
a processor running an operating system coupled to the display, the device configured to identify content entered by a user of the device and to automatically initiate a select message file related to the content entered as a result of a user-initiated implementation of a predetermined feature of the device that is not related to the message file and to allow the user-initiated implementation of the predetermined feature to proceed only after the user closes the select message.

2. The device of claim 1, wherein the device is wireless.

3. The device of claim 2, wherein the device is a cellular phone.

4. The device of claim 1, wherein the user-initiated interaction is answering a phone call.

5. The device of claim 1, wherein the predetermined feature is a select condition of the device being met, the select condition being that the device is proximate a specified GPS coordinate.

6. The device of claim 1, wherein the predetermined feature is an operator defined rule including a predetermined time interval.

7. The device of claim 1, wherein the select message file is an audio and/or visual file.

8. The device of claim 1, wherein the predetermined feature is a display swipe to activate the phone.

9. The device of claim 1, wherein the message file is selected based on geographical data relating to the device's position.

10. The device of claim 2, wherein the message file is selected based on one of a text and an e-mail sent from the device.

11. The device of claim 1, wherein the message file is an advertisement.

12. The device of claim 1, wherein the message file is a survey.

13. A cellular phone system comprising:
a cellular phone including a display; and
one or more a processors executing instructions stored on a physical memory device, the instructions including the acts of:
identifying content entered by a user of the system,
automatically initiating a message related to the entered content on the display as a result of a user-activated feature of the phone that is not related to the message,
activating the feature only after the user closes the message, and
in response to the user closing the message, determining a credit value associated with the activated feature and the message
transmitting the credit value to a communications interface for receipt and storage by a third-party server over a network connected to the cellular phone system, the credit value being stored in a user-account associated with the user of the cellular phone system.

14. The cellular phone system of claim 13, wherein after the credit value exceeds a predetermined threshold value, providing options for items of value to be redeemed in exchange for a credit value exceeding the threshold value.

15. The cellular phone system of claim 14, wherein the items of value are stored on third-party servers external to the cellular phone system.

16. A cellular phone messaging system comprising:
a cellular phone having a display; and
software in the cellular phone configured to identify content entered by a user of the device and to automatically initiate a message related to the entered content on the display as a result of a user activated feature of the phone that is not related to the message and to activate the feature only after the user closes the message.

17. The cellular phone system of claim 16, wherein the user activated feature is a display swipe to initiate operation of the cellular phone.

18. The cellular phone system of claim 16, wherein the message is an advertisement.

19. The cellular phone system of claim 18, wherein the advertisement is selected based on user data from the cellular phone and/or a geographic location of the cellular phone.

20. The cellular phone system of claim 16, wherein the message file is selected based on one of a text and an e-mail sent from the device.
